(19) United States
(12) Patent Application Publication
(10) Pub. No.: US 2010/0065977 A1
(43) Pub. Date: Mar. 18, 2010

(54) FILLING MATERIALS FOR USE IN METAL PROCESSING AND METHODS OF USE THEREOF

(76) Inventor: Joseph R. Quigley, Pittsburgh, PA (US)

Correspondence Address: HENRY E. BARTONY, JR, BARTONY & ASSOCIATES LLC, P.O. BOX 910, BUTLER, PA, 16003-0910, US

(21) Appl. No.: 12/209,308

(22) Filed: Sep. 12, 2008

(51) Int. Cl. F27D 1/16; C04B 35/52; C04B 35/10; C04B 35/04; C04B 35/42

(52) U.S. Cl. 264/30; 501/101; 501/100; 501/127; 501/117

(57) ABSTRACT

In one aspect, the present invention provides a method of providing a filling material for use in connection with an opening in a container used in molten metal processing including: recovering used refractory bricks; crushing the used refractory bricks into particles; and covering the opening with the particles.

### BACKGROUND OF THE INVENTION

The present invention relates to filling materials for use in metal processing and to methods of use thereof and, particularly, to filling materials fabricated from used refractory bricks and use thereof as free open filling materials in steelmaking processes.

The following information is provided to assist the reader to understand the invention disclosed below and the environment in which it will typically be used. The terms used herein are not intended to be limited to any particular narrow interpretation unless clearly stated otherwise in this document. References set forth herein may facilitate understanding of the present invention or the background of the present invention. The disclosure of all references cited herein are incorporated by reference.

In steelmaking applications electric furnaces are often equipped with an eccentric bottom tapping (EBT) device to allow for bottom tapping of molten steel from the furnace into ladles. EBT tap holes are typically approximately 6 to 8 inches in diameter and are approximately 3 feet long. See, for example, U.S. Pat. Nos. 4,523,747, 6,316,106, and 6,818,175, Published European Patent Application No. EP1201336 and Published PCT International Patent Application No. WO/99/01710, the disclosures of which are incorporated herein by reference. The use of EBT tap holes allows removal of molten metal while reducing the inclusion of nitrogen and slag in the molten metal. Slag is produced during steelmaking and smelting processes in a number of ways and includes undesired impurities in the molten metals being processed, which float to the top during melt processing. Metals also start to oxidize in the melt state, and slag forms a protective crust of oxides on the top of the liquid metal.

EBT tap holes are normally filled with a filling material such as tap hole sand or aggregate to protect the release mechanism/valve. Normally an EBT tap hole will require about 100-200 lbs. of tap hole sand or aggregate per application. To operate the EBT device, the cavity is filled with an inert, free flowing, high melting point filling material (EBT sand or aggregate) that forms a barrier between the molten steel and the gate such that when the gate is opened the inert material discharges freely, allowing the molten steel to tap out of the electric furnace. Material that are normally used as tap hole fills include olivine and silica sands. Olivine is a magnesium silicate mineral with relatively low cost and high melting point. The particle size that is most often used for EBT Tap Hole fill is from ¼ inch to 50 mesh.

Other minerals that are used in this application include bauxite and Magnesium Oxide, although they are less popular than olivine or silica as a result of higher cost. These higher cost minerals are often used when the silica contamination from the silica or olivine is not desirable.

It is desirable to develop less costly alternatives to currently available free open filling materials.

### SUMMARY OF THE INVENTION

In one aspect, the present invention provides a method of providing a filling material for use in connection with an opening in a container used in molten metal processing including: recovering used refractory bricks; crushing the used refractory bricks into particles; and covering the opening with the particles.

The used refractory bricks can, for example, include at least one of alumina magnesia carbon refractory bricks, MgO carbon refractory bricks, high alumina refractory bricks, fireclay refractory brick or magnesite-chrome refractory bricks. The used refractory bricks can include at least two of alumina magnesia carbon refractory bricks, MgO carbon refractory bricks, high alumina refractory bricks, fireclay bricks and magnesite chrome bricks which are crushed into a mixture of particles.

In several embodiments, the refractory bricks are formed from a material having a pyrometric equivalence index of at least 28.

The method can further include sizing the particles so that the particle size of at least 90% (or even at least 95%, or even at least 97% or more) of the particles of the filling material is in the range of approximately ⅜ inch to approximately 100 mesh. Further, at least 90% (or even at least 95%, or even at least 97% or more) of the particles can be in the range of approximately ⅜ inch to 70 mesh, in the range of approximately ⅜ inch to 50 mesh or in the range of approximately 4 mesh to 50 mesh.

In several embodiments, the molten metal processing is steelmaking. The opening can, for example, be an eccentric bottom tapping tap hole in a steelmaking furnace. The opening can also be an opening of a sliding gate in a steelmaking ladle.

In a number of embodiments, the used refractory bricks are recovered from at least one steelmaking ladle.

In another aspect, the present invention provides a method of producing steel using a container including an opening for removing molten steel from the container; including: covering the opening with a filling material, the filling material being formed by crushing used refractory bricks into particles.

The used refractory bricks can, for example, include at least one of alumina magnesia carbon refractory bricks, MgO carbon refractory bricks, high alumina refractory bricks, fireclay bricks and magnesite chrome bricks. The used refractory bricks can include at least two of alumina magnesia carbon refractory bricks, MgO carbon refractory bricks, high alumina refractory bricks, fireclay bricks and magnesite chrome bricks which are crushed into a mixture of particles.

In several embodiments, the used refractory bricks are formed from a material having a pyrometric equivalence index of at least 28.

As described above, the method can further include sizing the particles so that the particle size of at least 90% (or even at least 95%, or even at least 97% or more) of the particles of the filling material is in the range of approximately ⅜ inch to approximately 100 mesh.

In a number of embodiments, the used refractory bricks are recovered from at least one steelmaking ladle.

In still another aspect, the present invention provides a composition; including particles formed by crushing used refractory bricks, wherein the used refractory bricks are formed from a material having a pyrometric equivalence index of at least 28. The particle size of at least 90% (or even at least 95%, or even at least 97% or more) of the particles is in the range of approximately ¼ inch to 70 mesh.

In several embodiments, the refractory bricks include at least one of alumina magnesia carbon refractory bricks, MgO carbon refractory bricks, high alumina refractory bricks, fireclay bricks or magnesite chrome bricks.

The used refractory bricks can, for example, be recovered from at least one steelmaking ladle.

The present invention, along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates a cutaway view of a ladle used in steelmaking.

FIG. 2 illustrates schematically a process of the present invention for producing a free open filling material.

FIG. 3A illustrates the use of a filling material of the present invention in connection with the opening or tap hole of an eccentric bottom tapping device of a steelmaking furnace wherein the EBT tap hole is in a closed state.

FIG. 3B illustrates the steelmaking furnace of FIG. 3A wherein the EBT tap hole has been opened to allow outflow of the molten metal.

### DETAILED DESCRIPTION OF THE INVENTION

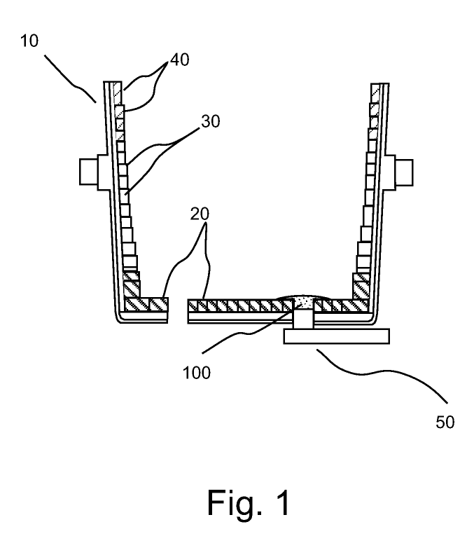

AMC (alumina magnesia carbon) refractory brick, MgO carbon refractory brick, and High alumina brick or castable are often used in steel making ladles. These refractory brick are often zoned in ladles to enhance ladle life. A simplified, cutaway view of a steelmaking ladle 10 is, for example, provided in FIG. 1. High alumina castable 20 is often used on the furnace bottom, AMC brick 30 is often used in the barrel of the ladle, and MgO Carbon 40 or magnesite chrome refractory bricks are often used in the slag line of the ladle. High alumina brick typically includes greater than 45% of alumina or Al₂O₃ and, more typically, greater than 60%. AMC brick typically includes Al₂O₃ (for example, in excess of 70 wt %), MgO (for example, approximately 10 to 15%) and carbon (for example, approximately 5%) MgO carbon bricks can include a high percentage of MgO (for example, greater than 80 wt %) and carbon (for example, in the form of graphite at approximately 10 wt %).

Periodically, it is necessary to rebuild such ladles. During the rebuilding process, the spent refractory is removed and the different types of spent refractory (resulting from zoning within the ladle) are mixed together. Currently, there is no good application for much of this used or spent refractory, in large part because of the mixture of materials from the ladle as well as the presence of trace amounts of slag and steel from the steelmaking process.

In the present invention, it has been discovered that scrap refractory including spent refractory brick as described above, when crushed and sized as described herein provides a good free open filling material 100 for use in connection, for example, with EBT tap holes. In addition to alumina magnesia carbon refractory brick, MgO carbon refractory brick, and high alumina refractory brick or castable, fireclay refractory brick (made predominantly or almost wholly from fireclay, and typically having an alumina content of approximately 24 to 45 wt % with the remainder being primarily silica or SiO₂) and magnesite-chrome refractory brick (including MgO and Cr₂O₃) are also suitable for use in the present invention. In general, crushed and screened refractory bricks having a high temperature resistance as, for example, evidenced by pyrometric cone equivalent (or P.C.E.) of at least 28 (as determined by ASTM C24-01 (2006), the disclosure of which is incorporated herein by reference) are suitable for use in the present invention.

As a result of heterogenicity in composition and structure, ceramic refractories do not exhibit a uniform melting point. The “refractories” of a refractory composition is characterized by optical determination of the pyrometric cone equivalent, which is the temperature at which the tip of a cone fabricated from a ground sample the test material softens to a point at which it touches a base plaque upon which the sample and a series of “standard pyrometric cones” (having known time-temperature softening values) rest while being heated. In general, the pyrometric cone equivalent value of the standard cone that touches the plaque at the same time as the tip of the test cone is reported as the pyrometric cone equivalent of the test cone.

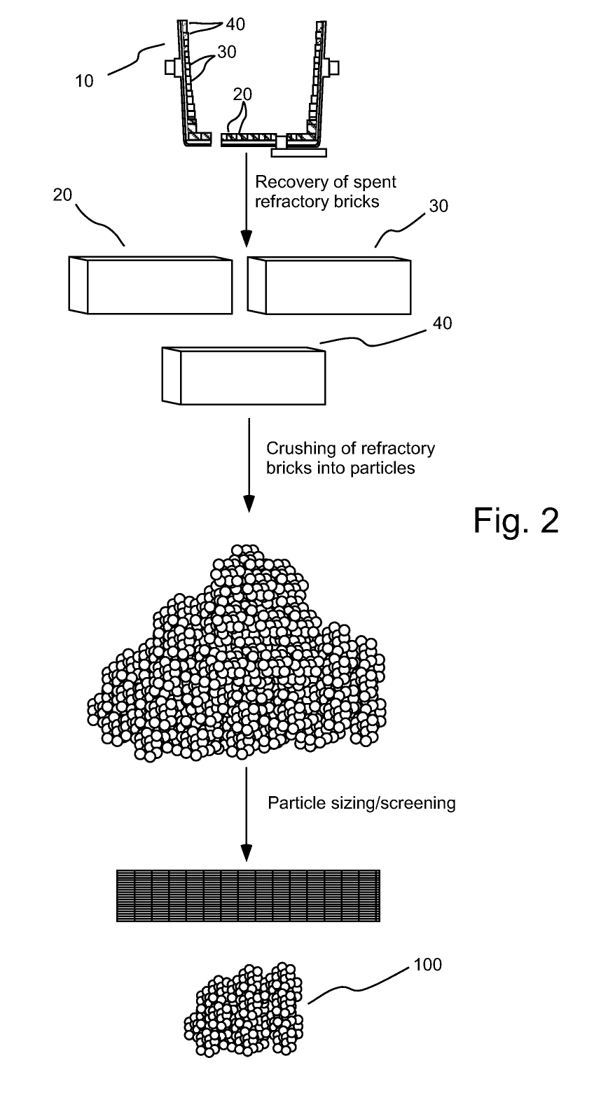

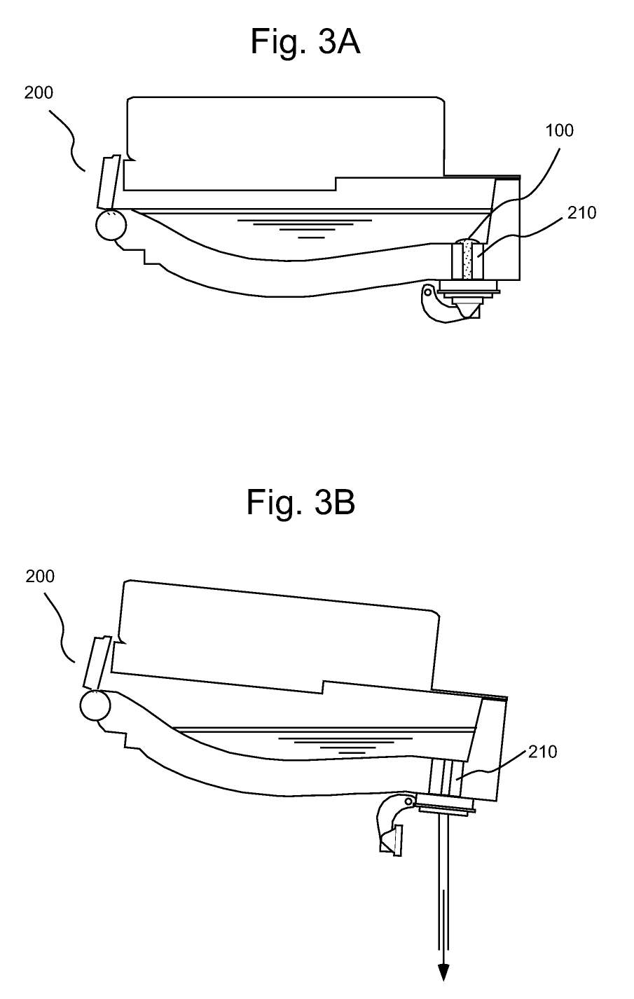

FIG. 2 provides a schematic representation of the recovery, crushing and screening/sizing processes. The use of resultant free opening filling material 100 in connection with and EBT tap hole 210 of a steelmaking furnace 100 (similar to that disclosed in U.S. Pat. No. 4,523,747) is illustrated in FIGS. 3A and 3B.

Similar to EBT tap holes in steelmaking furnaces, steel ladles such as ladle 10 are also equipped with a device for tapping steel through an opening equipped, for example, with a slide gate 50. As slide gate openings are typically smaller that EBT openings, a finer (that is, having a smaller particle size) free open filling material/sand is often used in connection with protection of the release mechanism in slide gate openings. Typically, filling materials that are used for this application are chrome sands, olivine sands, and zircon sands. As illustrated in FIG. 1, free open filling material 100 of the present invention can also be used in connection with slide gate openings of steelmaking ladles.

### EXPERIMENTAL EXAMPLES

### Example 1

Spent scrap refractory brick was recovered from used ladle brick from a steelmaking operation. The brick included primarily AMC brick (approximately 50-60% by weight) with amounts of alumina castable with alumina refractory brick (approximately 40-50%) and MgO Carbon brick (less than approximately 10%). The brick was crushed and screened to produce a product having a chemical analysis set forth in Table 1 and a particle size distribution set forth in Table 2. In initial experiments, 3,000 lbs. of this material was tested as an EBT free open material in a steelmaking furnace with satisfactorily results (approximately 100% successful free opening). In Table 2, the designation “pan” refers to those particles smaller than the smallest mesh size (70 in Table 2). In this example, it was desired to produce a product having a particle size range primarily between 4 mesh and 50 mesh.

TABLE 1

| Species | % (weight) |
|---|---|
| Al₂O₃ | 73.86 |
| SiO₂ | 14.03 |
| MgO | 7.26 |
| C | 1.49 |
| CaO | 1.47 |
| TiO₂ | 2.28 |
| Fe₂O₃ | 1.51 |

TABLE 2

| Particle Size/Mesh | % (weight) |
|---|---|
| 4 | 0.14% |
| 10 | 56.36% |
| 20 | 25.65% |
| 40 | 13.54% |
| 70 | 0.03% |
| pan | 0.22% |

All particle sizes referenced by mesh size herein refer to USA Standard sieve numbers. Specified sieve openings for a number of sieve sizes are set forth in Table 1.

TABLE 1

Specified
Sieve Opening

| Bureau of Standards | | Microns |
|---|---|---|
| Sieve Number | Inches | (μm) |
| 4 | .187 | 4760 |
| 5 | .157 | 4000 |
| 6 | .132 | 3360 |
| 7 | .111 | 2830 |
| 8 | .0937 | 2380 |
| 10 | .0787 | 2000 |
| 12 | .0661 | 1680 |
| 14 | .0555 | 1410 |
| 16 | .0469 | 1190 |
| 18 | .0394 | 1000 |
| 20 | .0331 | 840 |
| 25 | .0280 | 710 |
| 30 | .0232 | 590 |
| 35 | .0197 | 500 |
| 40 | .0165 | 420 |
| 45 | .0138 | 350 |
| 50 | .0117 | 297 |
| 60 | .0098 | 250 |
| 70 | .0083 | 210 |
| 80 | .0070 | 177 |
| 100 | .0059 | 149 |
| 120 | .0049 | 125 |
| 140 | .0041 | 105 |
| 170 | .0035 | 88 |
| 200 | .0029 | 74 |
| 230 | .0024 | 63 |
| 270 | .0021 | 53 |
| 325 | .0017 | 44 |

### Example 2

Spent scrap refractory brick was recovered from used ladle brick from a steelmaking operation. The brick included AMC brick (approximately 30-40% by weight) and alumina castable with alumina refractory brick (approximately 50-60%). The brick was crushed and screened to produce a product with the chemical analysis set forth in Table 4 and the particle size distribution set forth in Table 5. In initial experiments, 12,000 lbs. of this material was tested as an EBT free open material in a steelmaking furnace with satisfactorily results (approximately 100% successful free opening). In this example, it was desired to produce a product having a particle size range primarily between 4 mesh and 20 mesh.

TABLE 4

| Species | % (weight) |
|---|---|
| Al₂O₃ | 81.75 |
| SiO₂ | 9.25 |
| MgO | 4.74 |
| C | 1.56 |
| CaO | 1.31 |
| TiO₂ | 1.76 |
| Fe₂O₃ | 0..52 |
| ZrO₂ | 0.52 |

TABLE 5

| Particle Size/Mesh | % (weight) |
|---|---|
| 4 | 0% |
| 8 | 47.00% |
| 18 | 46.31% |
| 20 | 5.25 |
| pan | 1.44% |

Repeated testing of this material resulted in successful EBT free open production.

### Example 3

Spent scrap refractory brick was recovered from used ladle brick from a steelmaking operation. The brick included primarily AMC brick (approximately 70-80% by weight) with minor amounts of alumina castable (less than 20% by weight) and MgO carbon brick (less than 15%). The brick was crushed and screened to produce a product with the chemical analysis set forth in Table 6 and the particle size distribution set forth in Table 7. In this example, it was desired to produce a product having a particle size range primarily between 4 mesh and 20 mesh.

TABLE 6

| Species | % (weight) |
|---|---|
| Al₂O₃ | 64.67 |
| SiO₂ | 7.51 |
| MgO | 20.63 |
| C | 3.7 |
| CaO | 2.1 |
| TiO₂ | 1.96 |
| Fe₂O₃ | 1.94 |
| ZrO₂ | 0.12 |

TABLE 7

| Particle Size/Mesh | % (weight) |
|---|---|
| 4 | 0.26% |
| 8 | 44.42% |
| 18 | 48.76% |
| 20 | 5.01% |
| 60 | 1.16% |
| pan | 0.36% |

The foregoing description and accompanying drawings set forth the preferred embodiments of the invention at the present time. Various modifications, additions and alternative designs will, of course, become apparent to those skilled in the art in light of the foregoing teachings without departing from the scope of the invention. The scope of the invention is indicated by the following claims rather than by the foregoing description. All changes and variations that fall within the meaning and range of equivalency of the claims are to be embraced within their scope.

What is claimed is:

1. A method of providing a filling material for use in connection with an opening in a container used in molten metal processing comprising:
recovering used refractory bricks;
crushing the used refractory bricks into particles; and
covering the opening with the particles.

2. The method of claim 1 wherein the used refractory bricks comprise at least one of alumina magnesia carbon refractory bricks, MgO carbon refractory bricks, high alumina refractory bricks, fireclay refractory brick or magnesite-chrome refractory bricks.

3. The method of claim 1 wherein the refractory bricks are formed from a material having a pyrometric equivalence index of at least 28.

4. The method of claim 3 further comprising sizing the particles so that the particle size of at least 90% of the particles of the filling material is in the range of approximately ⅜ inch to approximately 100 mesh.

5. The method of claim 3 wherein the opening is an eccentric bottom tapping tap hole and the particle size of at least 90% of the particles is in the range of approximately ⅜ inch to 70 mesh.

6. The method of claim 3 wherein the opening is an eccentric bottom tapping tap hole and the particle size of at least 90% of the particles is in the range of approximately ⅜ inch to 50 mesh.

7. The method of claim 3 wherein the opening is an eccentric bottom tapping tap hole and the particle size of at least 97% of the particles is in the range of approximately ⅜ inch to 50 mesh.

8. The method of claim 3 wherein the opening is an eccentric bottom tapping tap hole and the particle size of at least 90% of the particles is in the range of approximately 4 mesh to 50 mesh.

9. The method of claim 3 wherein the opening is an eccentric bottom tapping tap hole and the particle size of at least 97% of the particles is in the range of approximately 4 mesh to 50 mesh.

10. The method of claim 1 wherein the used refractory bricks comprise at least two of alumina magnesia carbon refractory bricks, MgO carbon refractory bricks, high alumina refractory bricks, fireclay bricks and magnesite chrome bricks which are crushed into a mixture of particles.

11. The method of claim 4 wherein the used refractory bricks comprise at least two of alumina magnesia carbon refractory bricks, MgO carbon refractory bricks, high alumina refractory bricks, fireclay bricks and magnesite chrome bricks which are crushed into a mixture of particles.

12. The method of claim 3 wherein the molten metal processing is steelmaking.

13. The method of claim 1 wherein the opening is an eccentric bottom tapping tap hole in a steelmaking furnace.

14. The method of claim 1 wherein the opening is an opening of a sliding gate in a steelmaking ladle.

15. The method of claim 1 wherein the used refractory bricks are recovered from at least one steelmaking ladle.

16. A method of producing steel using a container comprising an opening for removing molten steel from the container; comprising:
covering the opening with a filling material, the filling material being formed by crushing used refractory bricks into particles.

17. The method of claim 16 wherein the used refractory bricks comprise at least one of alumina magnesia carbon refractory bricks, MgO carbon refractory bricks, high alumina refractory bricks, fireclay bricks and magnesite chrome bricks.

18. The method of claim 16 wherein the used refractory bricks comprise at least two of alumina magnesia carbon refractory bricks, MgO carbon refractory bricks, high alumina refractory bricks, fireclay refractory bricks and magnesite chrome refractory bricks which are crushed into a mixture of particles.

19. The method of claim 16 wherein the used refractory bricks are formed from a material having a pyrometric equivalence index of at least 28.

20. The method of claim 16 further comprising sizing the particles so that the particle size of at least 90% of the particles of the filling material is in the range of approximately ⅜ inch to approximately 100 mesh.

21. The method of claim 16 wherein the used refractory bricks are recovered from at least one steelmaking ladle.

22. A composition: comprising:
particles formed by crushing used refractory bricks, wherein the used refractory bricks are formed from a material having a pyrometric equivalence index of at least 28, the particle size of at least 90% of the particles being in the range of approximately ⅜ inch to 100 mesh.

23. The composition of claim 22 wherein the refractory bricks comprise at least one of alumina magnesia carbon refractory bricks, MgO carbon refractory bricks, high alumina refractory bricks, fireclay bricks or magnesite chrome bricks.

24. The composition of claim 22 wherein the used refractory bricks are recovered from at least one steelmaking ladle.
